(19) United States
(12) Patent Application Publication
(10) Pub. No.: US 2012/0195461 A1
(43) Pub. Date: Aug. 2, 2012

(54) CORRELATING AREAS ON THE PHYSICAL OBJECT TO AREAS ON THE PHONE SCREEN

(75) Inventor: Roy Lawrence Ashok Inigo, San Diego, CA (US)

(73) Assignee: QUALCOMM Incorporated, San Diego, CA (US)

(21) Appl. No.: 13/018,187

(22) Filed: Jan. 31, 2011

(51) Int. Cl. G06K 9/00

(52) U.S. Cl. 382/103

(57) ABSTRACT

A mobile platform renders an augmented reality graphic to indicate selectable regions of interest on a captured image or scene. The region of interest is an area that is defined on the image of a physical object, which when selected by the user can generate a specific action. The mobile platform captures and displays a scene that includes an object and detects the object in the scene. A coordinate system is defined within the scene and used to track the object. A selectable region of interest is associated with one or more areas on the object in the scene. An indicator graphic is rendered for the selectable region of interest, where the indicator graphic identifies the selectable region of interest.

### BACKGROUND

In augmented reality (AR) applications, a real world object is imaged and displayed on a screen along with computer generated information, such as an image or textual information. AR can be used to provide information, either graphical or textual, about a real world object, such as a building or product. The ability of the user to interact with the displayed objects, however, is limited and non-intuitive. Thus, what is needed is an improved way to interact with objects displayed in AR applications.

### SUMMARY

A mobile platform renders an augmented reality graphic to indicate selectable regions of interest on an object in a captured scene. The selectable region of interest is an area that is defined on the image of a physical object, which when selected by the user can generate a specific action, such as rendering an AR graphic or text or controlling the real-world object. The mobile platform captures and displays a scene that includes an object and detects the object in the scene. A coordinate system is defined within the scene and used to track the object. A selectable region of interest is associated with one or more areas on the object in the scene. An indicator graphic is rendered for the selectable region of interest, where the indicator graphic identifies the selectable region of interest.

### BRIEF DESCRIPTION OF THE DRAWING

FIGS. 1A and 1B illustrate a front side and back side, respectively, of a mobile platform capable of rendering augmented reality graphics as an indication of regions of the image with which the user may interact.

FIG. 2 illustrates a front side of a mobile platform displaying a real-world object.

FIG. 3 is a flow chart of correlating an area on a physical object with an AR region of interest on a display.

FIG. 4 illustrates a front side of a mobile platform displaying a real-world object and rendered indicator graphics for selectable regions of interest.

FIG. 5 illustrates a front side of a mobile platform displaying a real-world object and rendered indicator graphics for selectable regions of interest with a user interacting with a region of interest by occluding the region of interest.

FIG. 6 illustrates a front side of a mobile platform displaying a real-world object and rendered indicator graphics for selectable regions of interest with a user interacting with a region of interest by tapping on the display.

FIG. 7 illustrates a front side of a mobile platform displaying a real-world object and rendered indicator graphics for selectable regions of interest and a rendered graphic resulting from the user's interaction with a region of interest.

FIG. 8 illustrates a front side of a mobile platform displaying a real-world object and rendered indicator graphics for selectable regions of interest and control of the real-world object resulting from the user's interaction with a region of interest.

FIG. 9 is a block diagram of a mobile platform capable of rendering augmented reality graphics as an indication of regions of the image with which the user may interact.

### DETAILED DESCRIPTION

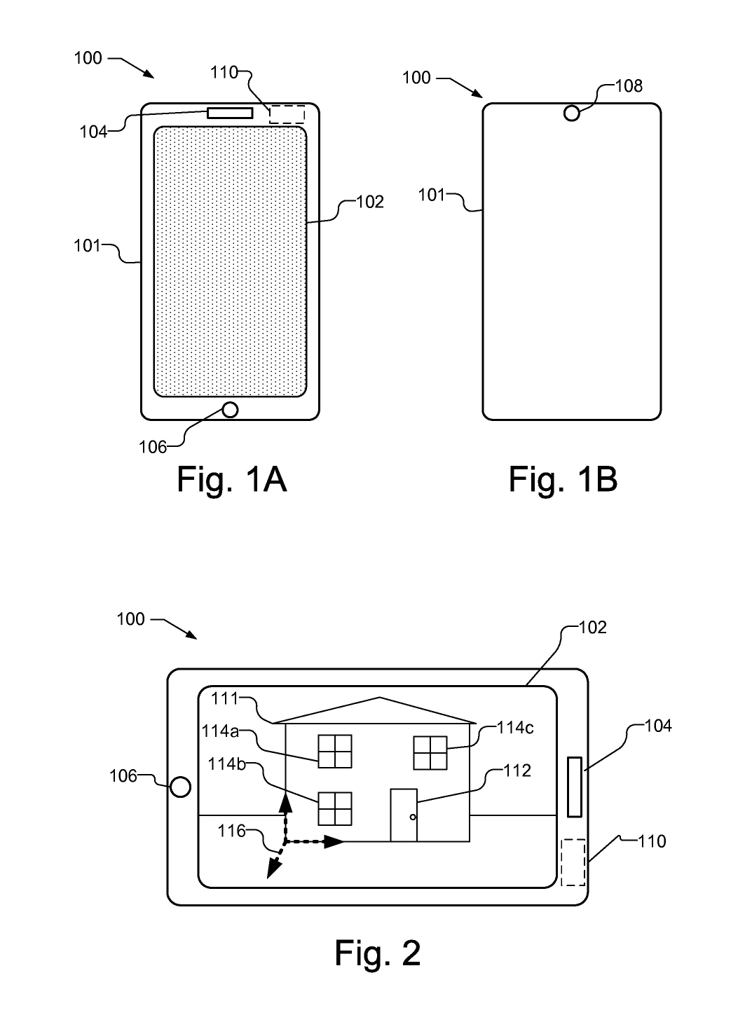

FIGS. 1A and 1B illustrate a front side and back side, respectively, of a mobile platform 100 capable of rendering augmented reality (AR) graphics as an indication of regions of the image with which the user may interact. In AR applications, specific “regions of interest” can be defined on the image of a physical object, which when selected by the user can generate an event that the mobile platform 100 may use to take a specific action. Simply defining a region of interest in the image of a physical object, however, provides no indication to a user that the selectable region of interest is present. Thus, while providing a selectable region of interest in an image is an interesting way of interacting in AR applications, the user will not know that interactivity is available or the user would be required to interact through trial and error. Thus, the mobile platform 100 provides a rendered graphic to indicate to the user that a particular area on the physical object can be selected.

The mobile platform 100 in FIGS. 1A and 1B is illustrated as including a housing 101, a display 102, which may be a touch screen display. The mobile platform 100 may also include a speaker 104 and microphone 106, e.g., if the mobile platform 100 is a cellular telephone. The mobile platform 100 further includes a forward facing camera 108 to image the environment that is displayed on display 102, which if desired may be a touch screen display. The mobile platform 100 may further include motion sensors 110, such as accelerometers, gyroscopes or the like, which may be used to assist in determining the pose of the mobile platform 100. It should be understood that the mobile platform 100 may be any portable electronic device such as a cellular or other wireless communication device, personal communication system (PCS) device, personal navigation device (PND), Personal Information Manager (PIM), Personal Digital Assistant (PDA), laptop, camera, or other suitable mobile device that is capable of augmented reality (AR).

FIG. 2 illustrates a front side of a mobile platform 100 held in landscape mode. The display 102 is illustrated as displaying a real-world object 111 in the form of a building with a door 112 and several windows 114a, 114b, and 114c (sometimes collectively referred to as windows 114). A computer rendered AR object may be displayed on the display 102 as well. The real world objects are produced using a camera on the mobile platform (not shown in FIG. 1), while any AR objects are computer rendered objects (or information). In AR applications, specific “regions of interest” of the image of the physical object can be defined. For example, the door 112 and/or one or more of the windows 114 may be defined as a selectable region of interest in the displayed image. When a region of interest is selected by the user, an event can be generated, such as providing information about the region of interest, providing a graphic, or physically controlling the real-world object.

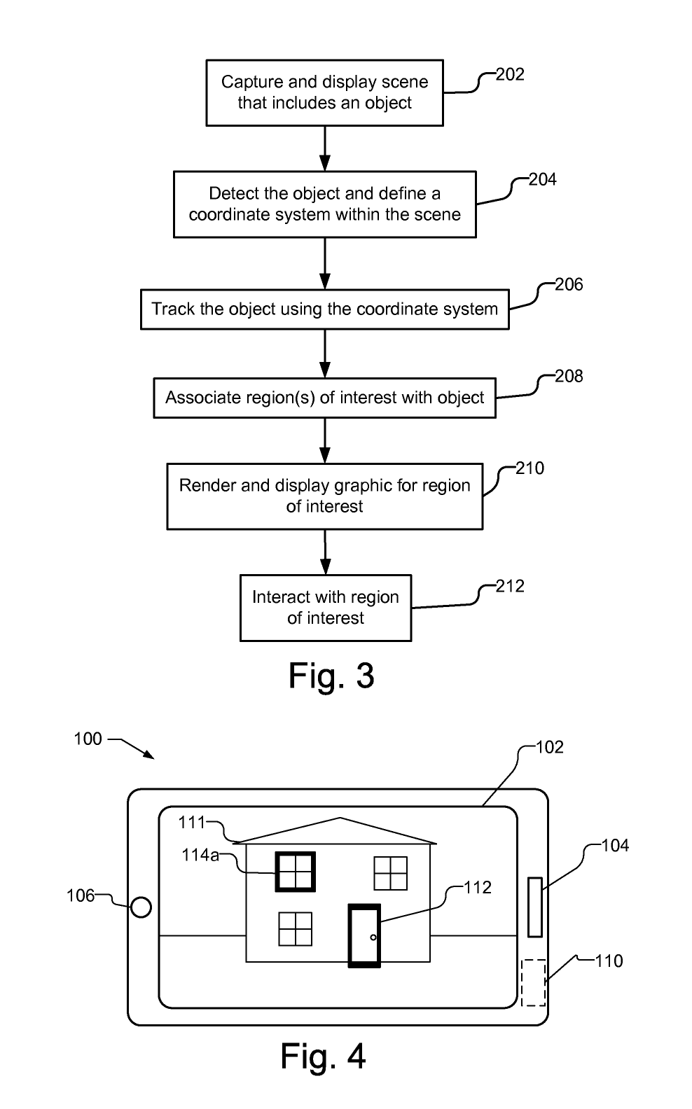

FIG. 3 is a flow chart of correlating an area on a physical object with an AR region of interest on a display. As illustrated, a scene that includes an object is captured and displayed (202). The captured scene is e.g., one or more frames of video produced by camera 108. The object may be a two-dimensional or three-dimensional object. For example, as illustrated in FIG. 1, the mobile platform 100 has a scene with object 111. The object in the scene is detected and a coordinate system within the scene is defined (204). For example, a specific location on the object may be defined as the origin, coordinate axes may be defined therefrom. As illustrated in FIG. 2, by way of example, the bottom left corner of the object 111 is defined as the origin of the coordinate system 116. It should be understood that FIG. 2 illustrates the coordinate system 116 for illustrative purposes and that the display 102 need not display the coordinate system 116 to the user. The units of the coordinate system 116 may be pixels or a metric obtained from the scene or image, e.g., some fraction of the width or height of the object, which may scale appropriate if the camera zooms in or out. The object is tracked using the defined coordinate system (206). The tracking gives the mobile platform's position and orientation (pose) information relative to the object. Tracking may be visually based, e.g., based on the position and orientation of the object 111 in the image. Tracking may also or alternatively be based on data from motion sensors 110. Use of data from the motion sensors 110 to track the object may be advantageous to continue to track the object 111 if the mobile platform 100 is moved so that the object 111 is completely or partially outside the captured scene, thereby avoiding the need to re-detect the object 111 when the object 111 re-appears in the captured scene.

One or more selectable regions of interest are associated with the real world object in the scene (208). An indicator graphic, such as a button or highlighting, is then rendered and displayed for the region of interest (208) to provide the user with a visual indicator of the presence of the selectable region of interest on the actual real world object. The indicator graphic may be displayed over or near the region of interest. FIG. 4, by way of example, illustrates the mobile platform 100 similar to that shown in FIG. 2, but shows the door 112 and window 114a highlighted, as an example of a rendered indicator graphic indicating that door 112 and window 114a of object 111 are selectable regions of interest. The indicator graphic may be rendered automatically or at the request of the user. For example, no indicator graphic may be provided until the user requests that an indication of the regions of interest be displayed by, e.g., tapping the display 102, quickly moving or shaking the mobile platform 100, or through any other desired interface. If desired, the indicator graphics may periodically disappear or change and may be recalled by the user if desired. Further, the selectable regions of interest may periodically disappear or change, along with the displayed indicator graphic. Thus, buttons may dynamically appear and disappear on various parts of the physical object.

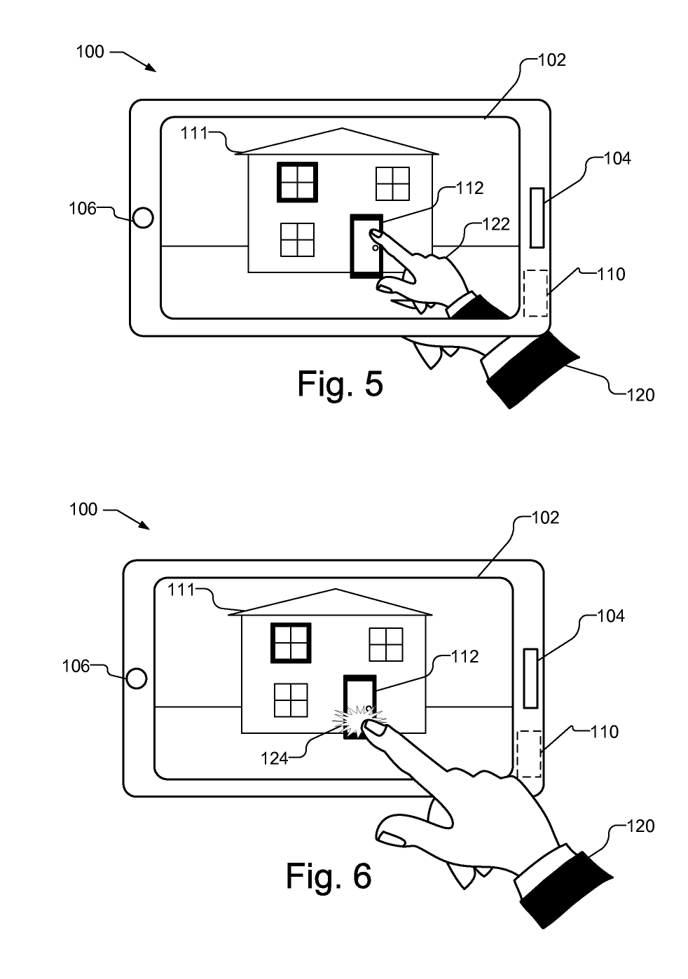

The user may interact with the region of interest by, e.g., occluding the region of interest or by tapping the touch screen at the region of interest (212). By way of example, FIG. 5, which is similar to FIG. 4, illustrates a user 120 occluding a region of interest, i.e., the door 112, by covering a portion of the door 112, as illustrated by the image of the user's hand 122 displayed over the door 112. FIG. 6, which is also similar to FIG. 4, but illustrates a user 120 interacting with a region of interest by tapping 124 on the display 102, which is a touch screen display, to select a region of interest, i.e., the door 112. The AR application may render another graphic or text in response to selection of a region of interest or perform any other desired function, including controlling the real-world object.

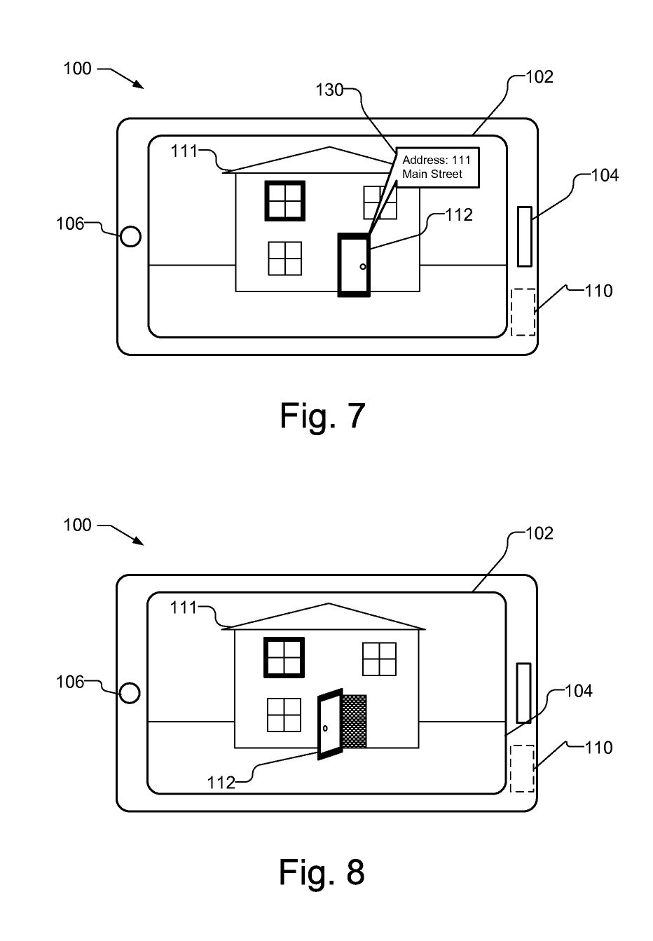

For example, FIG. 7 is similar to FIG. 4, but illustrates the mobile platform 100 displaying the object 111 after the door 112 has been selected by the user. The user's interaction with the region of interest results in the rendering of a graphic 130 showing the address of the object 111. Of course, any desired graphic or information may be rendered and displayed. FIG. 8 similarly illustrates the mobile platform 100 after the door 112 has been selected by the user, but illustrates the user's interaction with the region of interest resulting in control of the real-world object 111, i.e., the door 112 of the object 111 is opened as a result of selection by the user. Interaction with the physical object 111 may be performed by the mobile platform transmitting a wireless signal to the object 111, which is received and processed to control the selected real world object, e.g., the door 112. The control signal may be transmitted directly to and received by the object 111, or may be transmitted to an intermediate controller, e.g., a server on a wireless network, that is accessed by the object to be controlled. Control of the real world object may require the object 111 to have an electronic control, e.g., environmental control of an air condition or heater, and/or a physical actuator, e.g., door opener.

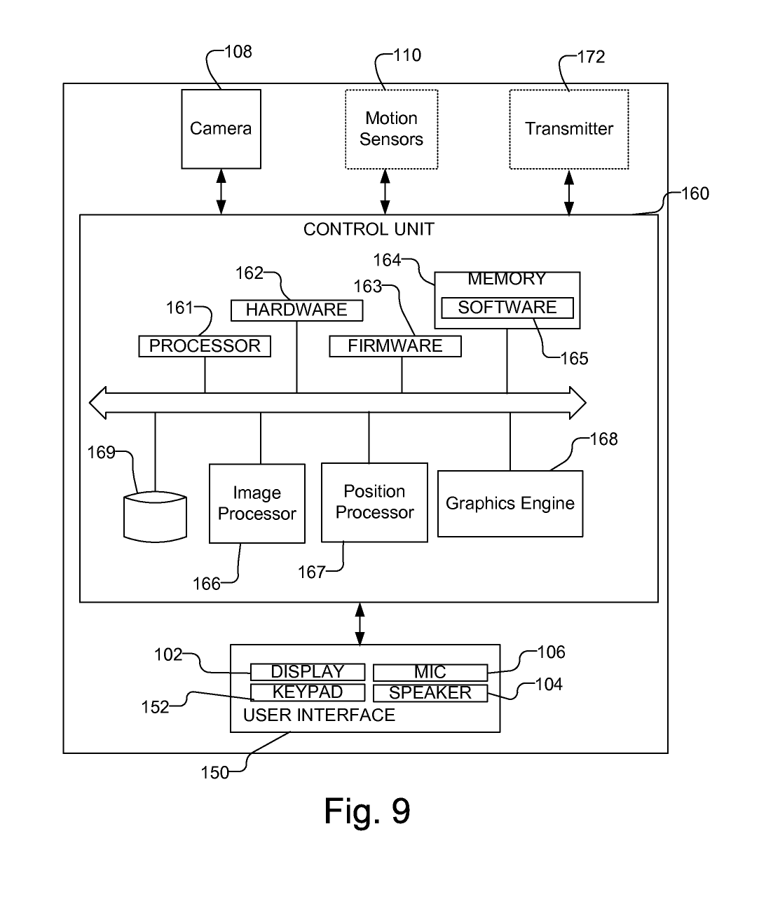

FIG. 9 is a block diagram of a mobile platform 100 capable of rendering augmented reality (AR) graphics as an indication of regions of the image with which the user may interact. The mobile platform 100 includes a means for capturing images of real world objects, such as camera 108, and motion sensors 110, such as accelerometers, gyroscopes, electronic compass, or other similar motion sensing elements. Mobile platform 100 may include other position determination methods such as object recognition using “computer vision” techniques. The mobile platform 100 may also include a means for controlling the real world object in response to user selection of the selectable region of interest, such as transmitter 172, which may be an IR or RF transmitter or a wireless a transmitter enabled to transmit one or more signals over one or more types of wireless communication networks such as the Internet, WiFi, cellular wireless network or other network. The mobile platform further includes a user interface 150 that includes a means for displaying captured scenes and rendered AR objects, such as the display 102. The user interface 150 may also include a keypad 152 or other input device through which the user can input information into the mobile platform 100. If desired, the keypad 152 may be obviated by integrating a virtual keypad into the display 102 with a touch sensor. The user interface 150 may also include a microphone 106 and speaker 104, e.g., if the mobile platform is a cellular telephone. Of course, mobile platform 100 may include other elements unrelated to the present disclosure, such as a wireless transceiver.

The mobile platform 100 also includes a control unit 160 that is connected to and communicates with the camera 108, motion sensors 110 and user interface 150. The control unit 160 accepts and processes data from the camera 108 and motion sensors 110 and controls the display 102 in response. The control unit 160 may be provided by a processor 161 and associated memory 164, hardware 162, software 165, and firmware 163. The control unit 160 may include an image processor 166 for processing the images from the camera 108 to detect real world objects. The control unit may also include a position processor 167 to define a coordinate system in the scene or image that includes the object and to track the object using the coordinate system, e.g., based on visual data and/or data received form the motion sensors 110. The control unit 160 may further include a graphics engine 168, which may be, e.g., a gaming engine, to render an indicator graphic for regions of interest as well as any other desired graphics, e.g., in response to the user interacting with the region of interest. The graphics engine 168 may retrieve graphics from a database 169, which may be in memory 164. The image processor 166, position processor 167 and graphics engine are illustrated separately from processor 161 for clarity, but may be part of the processor 161 or implemented in the processor based on instructions in the software 165 which is run in the processor 161. It will be understood as used herein that the processor 161 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The device includes means for detecting the object, which may include the image processor 166. The device may further include a means for defining a coordinate system within the scene, which may be, e.g., position processor 167, and a means for tracking the object using the coordinate system, which may include, e.g., the image processor 166, position processor 167, as well as the motion sensors 110 if desired. The device further includes a means for associating a selectable region of interest on the object in the scene, which may be, e.g., processor 161. A means for rendering an indicator graphic for the selectable region of interest may be the graphics engine 168, which accesses database 169. A means for responding to a user interaction to select the selectable region of interest may be, e.g., the processor 161 responding to the user interaction via the user interface 150 and/or motion sensors 110. A means for rendering a graphic in response to user selection of the selectable region of interest may include the graphics engine 168, which accesses database 169.

The methodologies described herein may be implemented by various means depending upon the application. For example, these methodologies may be implemented in hardware 162, firmware 163, software 165, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 164 and executed by the processor 161. Memory may be implemented within or external to the processor 161.

If implemented in firmware and/or software, the functions may be stored as one or more instructions or code on a computer-readable medium. Examples include non-transitory computer-readable media encoded with a data structure and computer-readable media encoded with a computer program. For example, the non-transitory computer-readable medium including program code stored thereon may include program code to display on the display a scene that includes an object, program code to detect the object, program code to define a coordinate system within the scene, program code to track the object using the coordinate system, program code to associate a selectable region of interest on the object in the scene, and program code to render and display an indicator graphic for the selectable region of interest, the indicator graphic identifying the selectable region of interest. The computer-readable medium may further include program code to respond to a user interaction to select the selectable region of interest. The computer-readable medium may further include program code to display the indicator graphic for the selectable region of interest in response to a user prompt. The computer-readable medium may further include program code to render and display a graphic in response to user selection of the selectable region of interest and/or to control a real world object in response to user selection of the selectable region of interest. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
capturing and displaying a scene that includes an object;
detecting the object and define a coordinate system within the scene;
tracking the object using the coordinate system;
associating a selectable region of interest on the object in the scene; and
render and display an indicator graphic for the selectable region of interest, the indicator graphic identifying the selectable region of interest.

2. The method of claim 1, further comprising responding to a user interaction to select the selectable region of interest.

3. The method of claim 2, wherein the user interaction is occluding the selectable region of interest in the scene.

4. The method of claim 2, wherein the user interaction is touching a touch screen display to select the selectable region of interest.

5. The method of claim 1, further comprising associating multiple selectable regions of interest in the scene.

6. The method of claim 1, wherein the indicator graphic is displayed for the selectable region of interest in response to a user prompt.

7. The method of claim 1, further comprising rendering and displaying a graphic in response to user selection of the selectable region of interest.

8. The method of claim 1, further comprising controlling a real world object in response to user selection of the selectable region of interest.

9. A mobile platform comprising:
a camera;
a processor connected to the camera;
memory connected to the processor;
a display connected to the memory; and
software held in the memory and run in the processor to cause the processor to display on the display a scene that includes an object, detect the object and define a coordinate system within the scene, track the object using the coordinate system, associate a selectable region of interest on the object in the scene, and render and display on the display an indicator graphic for the selectable region of interest, the indicator graphic identifying the selectable region of interest.

10. The mobile platform of claim 9, wherein the software that is run in the processor causes the processor to response to a user interaction to select the selectable region of interest.

11. The mobile platform of claim 10, wherein the user interaction is occluding the selectable region of interest in the scene.

12. The mobile platform of claim 10, wherein the display is a touch screen display, and wherein the user interaction is touching the touch screen display to select the selectable region of interest.

13. The mobile platform of claim 9, wherein the software that is run in the processor causes the processor to associate multiple selectable regions of interest in the scene.

14. The mobile platform of claim 9, wherein the software that is run in the processor causes the processor to display on the display the indicator graphic for the selectable region of interest in response to a user prompt.

15. The mobile platform of claim 9, further comprising software that is run in the processor to cause the processor to render and display on the display a graphic in response to user selection of the selectable region of interest.

16. The mobile platform of claim 9, further comprising software that is run in the processor to cause the processor to control a real world object in response to user selection of the selectable region of interest.

17. A device comprising:
means for capturing a scene that includes an object;
means for detecting the object;
means for defining a coordinate system within the scene;
means for tracking the object using the coordinate system;
means for associating a selectable region of interest on the object in the scene;
means for rendering an indicator graphic for the selectable region of interest, the indicator graphic identifying the selectable region of interest; and
means for displaying the scene and the indicator graphic.

18. The device of claim 17, further comprising means for responding to a user interaction to select the selectable region of interest.

19. The device of claim 18, wherein the user interaction is occluding the selectable region of interest in the scene.

20. The device of claim 18, wherein the user interaction is touching a touch screen display to select the selectable region of interest.

21. The device of claim 17, wherein the means for associating the selectable region of interest on the object associates multiple selectable regions of interest in the scene.

22. The device of claim 17, wherein the indicator graphic is displayed by the means for displaying in response to a user prompt.

23. The device of claim 17, further comprising a means for rendering a graphic in response to user selection of the selectable region of interest.

24. The device of claim 17, further comprising a means for controlling a real world object in response to user selection of the selectable region of interest.

25. A non-transitory computer-readable medium including program code stored thereon, comprising:
program code to display on the display a scene that includes an object;
program code to detect the object;
program code to define a coordinate system within the scene;
program code to track the object using the coordinate system;
program code to associate a selectable region of interest on the object in the scene; and
program code to render and display an indicator graphic for the selectable region of interest, the indicator graphic identifying the selectable region of interest.

26. The non-transitory computer-readable medium of claim 25, further comprising program code to respond to a user interaction to select the selectable region of interest.

27. The non-transitory computer-readable medium of claim 26, wherein the user interaction is occluding the selectable region of interest in the scene.

28. The non-transitory computer-readable medium of claim 26, wherein the user interaction is touching a touch screen display to select the selectable region of interest.

29. The non-transitory computer-readable medium of claim 25, wherein the program code to associate the selectable region of interest on the object in the scene associates multiple selectable regions of interest in the scene.

30. The non-transitory computer-readable medium of claim 25, further comprising program code to display the indicator graphic for the selectable region of interest in response to a user prompt.

31. The non-transitory computer-readable medium of claim 25, further comprising program code to render and display a graphic in response to user selection of the selectable region of interest.

32. The non-transitory computer-readable medium of claim 25, further comprising program code to control a real world object in response to user selection of the selectable region of interest.
